(19) United States
(12) Patent Application Publication
(10) Pub. No.: US 2021/0095510 A1
(43) Pub. Date: Apr. 1, 2021

(54) HINGE DEVICE FOR ROTARY DOOR

(71) Applicant: PARTSTEC Construction Co., Ltd, Gumi-si (KR)

(72) Inventors: Young Tak LEE, Gumi-si (KR); Kil Seok JEONG, Gumi-si (KR)

(21) Appl. No.: 16/875,143

(22) Filed: May 15, 2020

(30) Foreign Application Priority Data
Sep. 30, 2019 (KR) 10-2019-0121084

(51) Int. Cl. E05F 3/22; E05F 1/12; E05F 3/20; E05F 5/02; E05D 11/10; E05D 7/00

(52) U.S. Cl. CPC E05F 3/227; E05F 1/1215; E05F 3/20; F25D 2323/024; E05D 11/105; E05D 7/0027; E05Y 2900/31; E05F 5/02

(57) ABSTRACT

A hinge device for a rotary door is mounted to a door that is rotating to open and close the door while being rotated in various manners. The hinge device can be rotated in a free stop type in a predetermined section after it is rotated by an external force, and is automatically reversely rotated in a section in which it is reversely rotated after the free stop rotation.

### CROSS REFERENCE TO RELATED APPLICATION

The present application claims priority to Korean Patent Application No. 10-2019-0121084, filed Sep. 30, 2019, the entire contents of which is incorporated herein for all purposes by this reference.

### BACKGROUND OF THE INVENTION

### 1. Field of the Invention

The present invention relates to a hinge device for a rotary door, and more particularly to a hinge device for a rotary door which is mounted to a door that is rotating to open and close the door while being rotated in various manners.

### 2. Description of the Prior Art

A structure in which a door is hinge-coupled to a body object such that the interior of the body object may be opened or closed is well known.

As an example, a refrigerator includes a body in which foods are kept, and a door that opens or closes the refrigerator.

When a big or heavy item or a number of items are introduced into or extracted from the interior of a refrigerator, it may be necessary to open the refrigerator door for a long time.

In a conventional general refrigerator, because the door is automatically closed when a large number of items are inserted into or extracted from the interior of the refrigerator, items have to be inserted into or extracted from the interior of the refrigerator while the user stops the refrigerator door such that the door is not closed.

### PRIOR TECHNICAL DOCUMENTS

[Patent Documents]

Korean Patent Application Publication No. 10-2006-0119459

Korean Patent Application Publication No. 10-2006-0099355

### SUMMARY OF THE INVENTION

The present invention provides a hinge device for a rotary door, by which items can be conveniently inserted into or extracted from the interior of a body object (a refrigerator or the like) while a user is not interfered by a user when the items are inserted or extracted as the door rotated from the body object to be opened can be maintained in an opened state.

In accordance with an aspect of the present invention, there is provided a hinge device for a rotary door, including a hollow housing, a shaft mounted in the interior of the housing to be rotatable, one end of which is exposed to the outside through one end of the housing, an opposite end of which is disposed in the interior of the housing, and in which a first seating recess is formed on an outer peripheral surface of the opposite end thereof, a clutch roll inserted into and disposed in the first seating recess, a clutch member, one end of which surrounds the opposite end of the shaft, having a first coupling boss protruding at an opposite end thereof, and in which a through-hole, into which the clutch roll is inserted to be disposed, is formed at the one end surrounding the shaft, a support member mounted on the opposite end of the housing and having a second coupling boss protruding toward the interior of the housing, and a torsion spring disposed in the interior of the housing, one end of which is coupled to the first coupling boss, and an opposite end of which is coupled to the second coupling boss, wherein a second recess, in which the clutch roll inserted into the through-hole is seated, is formed on an inner peripheral surface of the housing, wherein when the shaft is rotated in a state in which the clutch roll is inserted into both the first seating recess and the through-hole, a rotational force of the shaft is transferred to the clutch member through the clutch roll such that the clutch member is rotated together with the shaft, and wherein when the shaft is rotated in a state in which the clutch roll is inserted into both the through-hole and the second seating recess, only the shaft is rotated independently while neither the clutch roll nor the clutch member is rotated.

The hinge device may include a compression section, in which when the shaft is rotated forwardly by an external force, the clutch member compresses the torsion spring while being rotated together with the shaft to a preset first angle at an initial stop location, a free stop section, in which when the shaft is rotated forwardly or reversely in a state in which the clutch exceeds the first angle, the shaft is freely rotated while the torsion spring is neither compressed nor released, and a restoration section, in which when the shaft is rotated reversely toward the inside of the first angle in the free stop section, the shaft is automatically rotated reversely by an elastic restoring force of the torsion spring and is restored to the initial stop location.

The second seating recess may be formed at a location corresponding to the first angle, the clutch roll may be inserted into and disposed in the first seating recess and the through-hole in the compression section and the restoration section such that the shaft, the clutch roll, and the clutch member are rotated together, and the clutch roll may be inserted into and disposed in the through-hole and the second seating recess in the free stop section such that the shaft is rotated independently from the clutch roll and the clutch member.

The depth of the first seating recess, the depth of the second seating recess, and the depth of the through-hole may be smaller than the diameter of the clutch roll, the center point of the clutch roll may be disposed outside the first seating recess in a state in which the clutch roll is inserted into and disposed in the first seating recess and the through-hole, and the center point of the clutch roll may be disposed outside the second seating recess in a state in which the clutch roll is inserted into and disposed in the second seating recess and the through-hole.

If the shaft is rotated forwardly and passes by the first angle in a state in which the clutch roll is inserted into and disposed in the first seating recess and the through-hole, the clutch roll may be separated from the first seating recess and may be inserted into and disposed in the first through-hole and the second seating recess as the shaft is rotated while the first seating recess, the through-hole, and the second seating recess are communicated with each other, and if the shaft is rotated reversely and passes by the first angle in a state in which the clutch roll is inserted into and disposed in the second seating recess and the through-hole, the clutch roll may be separated from the first seating recess and may be inserted into and disposed in the first through-hole and the second seating recess as the shaft is rotated by the elastic restoring force of the torsion spring while the first seating recess, the through-hole, and the second seating recess are communicated with each other.

A reverse rotational force due to the elastic restoring force of the torsion spring may be added to the shaft at the initial stop location.

The first seating recesses may be disposed at an interval of 120 degrees, three clutch rolls may be provided, the second seating recesses may be disposed at an interval of 120 degrees, and the first angle may be an angle that is smaller than 90 degrees at the initial stop location.

The housing may include a first housing, in which the shaft is disposed in the interior thereof, and a second housing, one end of which is coupled to an end of the first housing, in which the support member is mounted on an opposite end thereof, and in which the torsion spring is disposed in the interior thereof, and a stop boss may protrude circumferentially between the one end and the opposite end of the clutch member, and the stop boss may be rotatable between the first housing and the second housing but may be mounted such that a linear movement of the stop boss is stopped.

The hinge device may further include a bearing surrounding the opposite end of the clutch member, and one end of the bearing may be stopped by and coupled to an inner peripheral surface of the one end of the second housing, and the stop boss may be disposed between the bearing and the opposite end of the first housing to be rotatable but to be mounted such that a linear movement thereof is stopped.

A rotational groove may be formed long on an outer peripheral surface of the shaft circumferentially, a stopper inserted into and disposed in the rotational groove may be mounted on the housing, and when the shaft is rotated, the shaft may be stopped by the stopper inserted into the rotational groove such that a rotational angle thereof is restricted.

The hinge device may further include a height adjusting nut screw-coupled to one end of the housing, a height adjusting ring, one end of which is exposed to the outside of one end of the height adjusting nut and one end of the housing and an opposite end of which is inserted and disposed between the height adjusting nut and the housing, and a snap ring coupling the height adjusting nut and the height adjusting ring such that the height adjusting nut and the height adjusting ring are moved together lengthwise, and when the height adjusting nut is rotated with respect to the housing, the height adjusting ring coupled through the snap ring may be moved in the lengthwise direction of the housing such that the distance of the height adjusting ring from the one end of the hosing is adjusted.

The above-described hinge device for a rotary door according to the present invention has the following effects.

Because a door rotated from a body object (a refrigerator or the like) to be opened can be maintained in an opened state, an item can be conveniently inserted into or extracted from the interior of the body object while a user is not interfered by the door when the item is inserted into or extracted from the body object.

In particular, according to the present invention, because a free stop type in which the door is not rotated when an external force is applied in a section that exceeds a first angle and the door is automatically rotated at less than the first angle, the door can be automatically rotated to be closed conveniently.

### BRIEF DESCRIPTION OF THE DRAWINGS

The above and other objects, features, and advantages of the present invention will be more apparent from the following detailed description taken in conjunction with the accompanying drawings, in which:

FIG. 1 is a diagram illustrating a state in which a hinge device for a rotary door according to an embodiment of the present invention is mounted on a refrigerator;

FIG. 2 is a perspective view of the hinge device for a rotary door according to the embodiment of the present invention;

FIG. 3 is a one-directional exploded perspective view of the hinge device for a rotary door according to the embodiment of the present invention;

FIG. 4 is another-directional exploded perspective view of the hinge device for a rotary door according to the embodiment of the present invention;

FIG. 5 is a perspective view of a coupling state of a clutch member of a shaft of the hinge device for a rotary door according to the embodiment of the present invention;

FIG. 6 is a cross-sectional view taken along line A-A of FIG. 2;

FIG. 7 is a cross-sectional view taken along line B-B of FIG. 2;

FIG. 8 is an illustration for explaining operations for angles of the hinge device for a rotary door according to the embodiment of the present invention when the hinge device is rotated;

FIGS. 9A-9F are cross-sectional views illustrating a state of a process of forwardly rotating the shaft of the hinge device for a rotary door according to the embodiment of the present invention in FIG. 7;

FIGS. 10A-10F are cross-sectional views illustrating a state of a process of reversely rotating the shaft of the hinge device for a rotary door according to the embodiment of the present invention in FIGS. 9A-9F;

FIG. 11 is a cross-sectional view illustrating a process of rotating the shaft in a cross-section taken along line C-C of FIG. 2; and

FIG. 12 is a view illustrating operational processes of a height adjusting nut and a height adjusting ring according to the embodiment of the present invention.

### DETAILED DESCRIPTION OF THE EXEMPLARY EMBODIMENTS

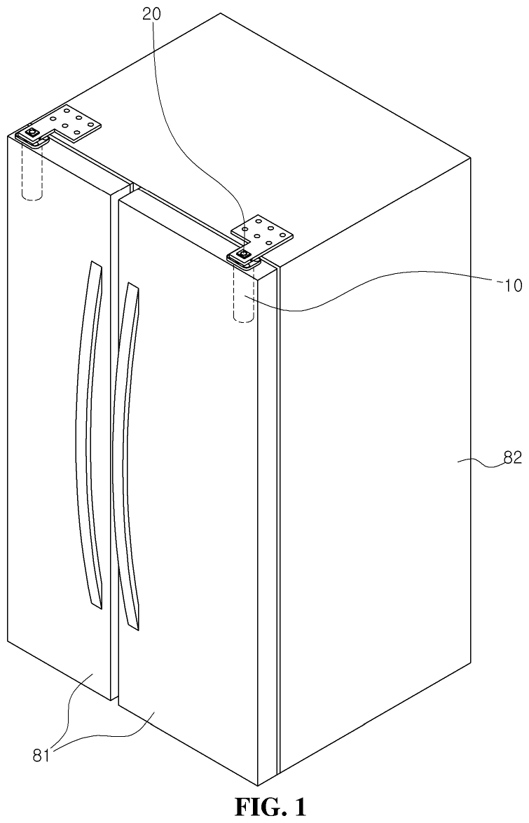

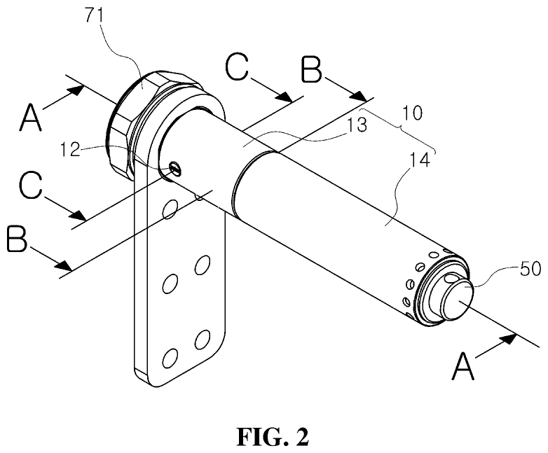

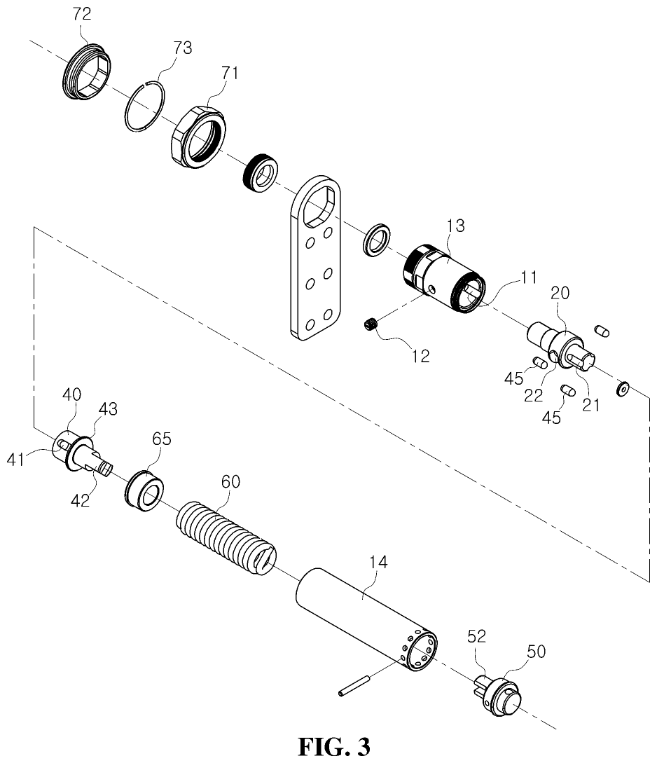

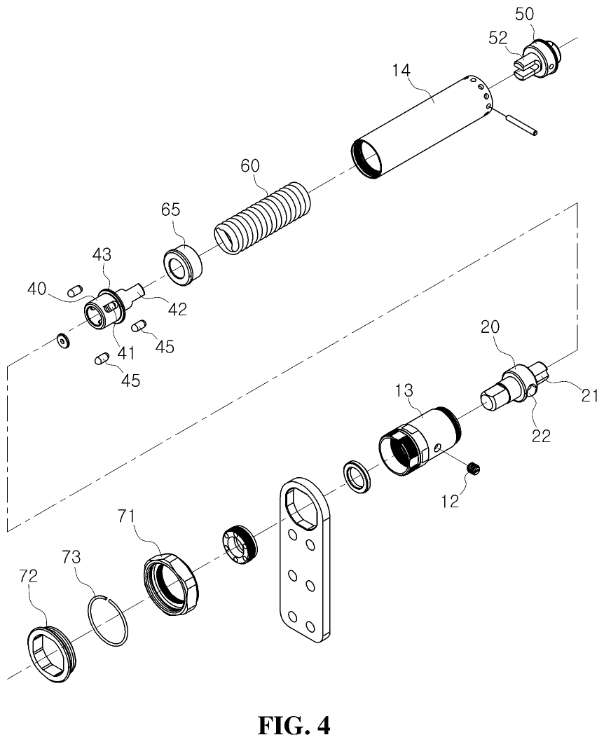

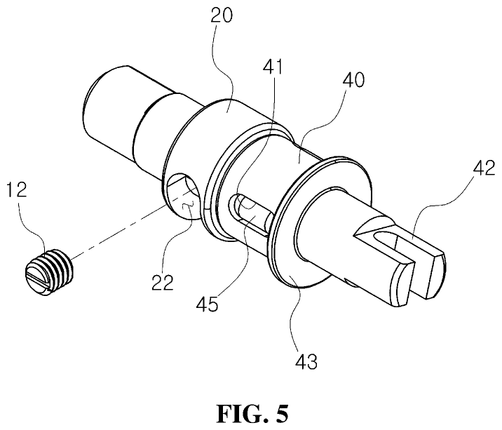

A hinge device for a rotary door of the present invention, as illustrated in FIGS. 1 to 7, includes a housing 10, a shaft 20, a clutch roll 45, a clutch member 40, a support member 50, and a torsion spring 60.

In the present invention, one of the housing 10 and the shaft 20 is relatively rotated with respect to the other one according to mounting locations thereof.

As illustrated in FIG. 1, generally, the housing 10 is fixedly mounted on an upper portion or a lower portion of a door 81 that is rotated and the shaft 20 is connected to a body object 82 (a refrigerator and the like), to which the door 81 is hinge-coupled, and thus the housing 10 is rotated with respect to the shaft 20 when the door 81 is rotated.

In the embodiment, it will be described for convenience of description with the premise that the shaft 20 is rotated with respect to the housing 10.

Of course, the shaft 20 may be fixed and the housing 10 may be installed to be rotated with respect to the shaft 20, but the operational process and the technical configuration and feature that is pursued by the present invention are the same.

The housing 10 has a hollow column shape.

A second seating recess 11, in which the clutch roll 45 is seated, is formed on an inner peripheral surface of the housing 10.

The second seating recess 11, as described below, is formed on the inner peripheral surface of the housing 10 to be recessed at a location corresponding to a preset first angle.

In the embodiment, the housing 10 is formed by coupling the first housing 13 and the second housing 14.

The shaft 20 is disposed in the interior of the first housing 13.

One end of the second housing 14 is coupled to an opposite end of the first housing 13, the support member 50 is mounted on an opposite end of the second housing 14, and the torsion spring 60 is disposed in the interior of the second housing 14.

The second seating recess 11 is formed on an inner peripheral surface of the opposite end of the first housing 13.

While the shaft 20 is mounted in the interior of the housing 10, in more detail, in the interior of the first housing 13 to be rotatable, and one end of the shaft 20 is exposed to the outside through one end of the housing 10 and an opposite end of the shaft 20 is disposed in the interior of the housing 10.

A first seating recess 21 is formed on an outer peripheral surface of an opposite end of the shaft 20.

The clutch roll 45 has a cylindrical shape, and is inserted into and disposed in the first seating recess 21.

One end of the clutch member 40 surrounds the opposite end of the shaft 20, and a first coupling boss 42 protrudes from an opposite end of the clutch member 40.

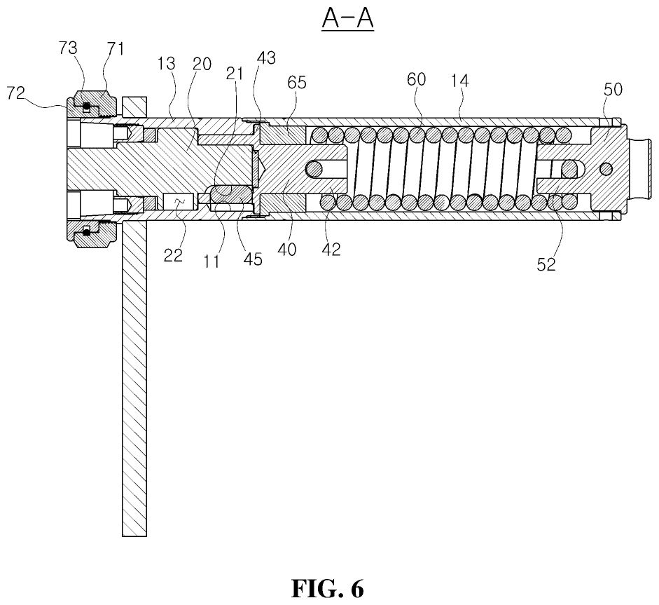

A stop boss 43 protrudes circumferentially between one end and an opposite end of the clutch member 40, and the stop boss 43, as illustrated in FIG. 6, may be rotated between the first housing 13 and the second housing 14 but may be mounted such that a linear movement of the stop boss is stopped.

Further, a bearing 65 that surrounds the opposite end of the clutch member 40 is mounted on the opposite end of the clutch member 40.

One end of the bearing 65 is stopped by and coupled to the inner peripheral surface of the one end of the second housing 14 and the coupling boss 43 is disposed between the bearing 65 and the opposite end of the first housing 13 whereby the bearing 65 is mounted to be rotated but such that a linear movement of the bearing 65 is stopped.

Due to the structure, the clutch member 40 and the bearing 65 may be rotated in the interior of the housing 10 but a linear movement thereof is not possible.

A through-hole 41, in which the clutch roll 45 is inserted into to be disposed, is formed at one end of the clutch member 40 that surrounds the shaft 20.

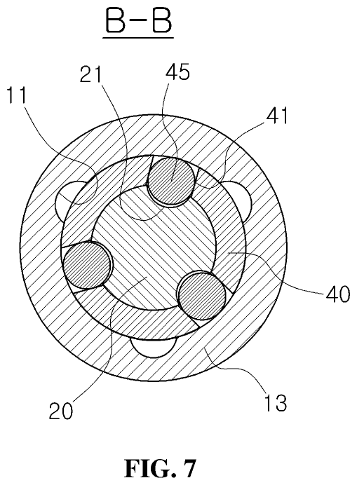

As illustrated in FIGS. 7, 9, and 10, the through-hole 41 is communicated with the first seating recess 21 or the second seating recess as the shaft 20 is rotated.

The clutch roll 45 inserted into the through-hole 41 is selectively inserted into and disposed in the first seating recess 21 or the second seating recess according to the rotational angle of the shaft 20 while being disposed in the through-hole 41.

When the shaft 20 is rotated in a state in which the clutch roll 45 is inserted into the first seating recess 21 and the through-hole 41, the rotational force of the shaft 20 is transferred to the clutch member 40 through the clutch roll 45 whereby the clutch member 40 is rotated together with the shaft 20.

Further, when the shaft 20 is rotated in a state in which the clutch roll 45 is inserted into the through-hole 41 and the second seating recess 11, only the shaft 20 is independently rotated while neither the clutch roll 45 nor the clutch member 40 is rotated.

As illustrated in FIG. 7, in the embodiment, the first seating recesses 21 are formed at an interval of 120 degrees, three clutch rolls are provided, and the second seating recesses 11 are formed at an interval of 120 degrees.

Unlike the embodiment, the numbers and the angles of the first seating recesses 21, the clutch rolls 45, and the second seating recesses 11 may be adjusted.

The support member 50 is mounted on the opposite end of the housing 10, in more detail, the opposite end of the second housing 14, and a second coupling boss 52 protrudes toward the interior of the housing 10.

While the torsion spring 60 is disposed in the interior of the housing 10, in more detail, at the opposite end of the second housing 14, the one end of the torsion spring 60 is coupled to the first coupling boss 42 formed in the clutch member 40 and the opposite end of the torsion spring 60 is coupled to the second boss 52 formed in the support member 50.

The torsion spring 60 applies a force for rotating the clutch member 40 in a reverse rotational direction.

Because the torsion spring 60 is positioned in a state in which it is compressed to a degree at an initial stop location at which the shaft 20 is not rotated, a reverse rotational force by an elastic restoring force of the torsion spring 60 is added to the shaft at the initial stop location.

Accordingly, the door 81 is maintained in a state in which it is attached to the body object 82 by applying a reverse rotational force to the shaft 20 even in a state in which an external force is not applied.

The hinge device for a rotary door of the present invention is divided into a compression section, a free stop section, and a restoration section to be operated.

The compression section is a section in which the torsion spring 60 is compressed, and is a section in which the torsion spring 60 is compressed while the clutch member 40 is rotated together with the shaft 20 from the initial stop location to a preset first angle when the shaft 20 is rotated by an external force.

The first angle is an angle that is smaller than 90 degrees from the initial stop location.

In the drawings of the embodiment, the first angle is 75 degrees as an example and it is illustrated that a section in which the clutch member 40 is forwardly rotated from the initial stop location, that is, 0 degree to 75 degrees is a compression section, but the present invention is not limited thereto.

In the compression section, the clutch roll 45 is inserted into and disposed in the through-hole 41 and the first seating recess 21 whereby the clutch roll 45 connects the shaft 20 and the clutch member 40 when the shaft 20 is rotated, the rotational force of the shaft 20 is transferred to the clutch member 40 while the shaft 20, the clutch roll 45, and the clutch member 40 are rotated together, and the torsion spring 60 is compressed as the clutch 40 is rotated.

The free stop section is a section in which the shaft 20 can be rotated freely while a force of the torsion spring 60 is not applied, and is a section in which the shaft is rotated freely while the torsion spring 60 is neither compressed nor released when the shaft 20 is rotated forwardly and/or reversely in a state in which the shaft 20 exceeds the first angle.

In the drawings of the embodiment, it is illustrated that the free stop section is from the first angle, that is, an angle that exceeds 75 degrees to 180 degrees.

In the free stop section, the clutch roll 45 is inserted into the through-hole 41 and the second seating recess 11 while the clutch roll 45 is not seated in the first recess 21 whereby the shaft 20 is rotated independently from the clutch roll 45 and the clutch member 40 when the shaft 20 is rotated.

The restoration section is a section in which the shaft 20 is reversely rotated to the initial stop location to be restored, and is a section in which the shaft 20 is automatically reversely rotated to be restored to the initial stop location by the elastic restoring force of the torsion spring 60 when the shaft 20 is reversely rotated from the free stop section to less than the first angle.

In the drawings of the embodiment, it is illustrated that a section in which the shaft 20 is reversely rotated from the first angle, that is, 75 degrees to 0 degrees is the restoration section.

In order that the clutch roll 45 is moved and inserted into to be disposed in the first seating recess 21 and the second seating recess 11 when the shaft 20 is rotated, as illustrated in FIG. 7, the depth of the first seating recess 21, the depth of the second seating recess 11, and the depth of the through-hole 41 are formed to be smaller than the diameter of the clutch roll 45.

Further, the center point of the clutch roll 45 is disposed outside the first seating recess 21 in a state in which the clutch roll 45 is inserted into and disposed in the first seating recess 21 and the through-hole 41, and the center point of the clutch roll 45 is disposed outside the second seating recess 11 in a state in which the clutch roll 45 is inserted into and disposed in the second seating recess 11 and the through-hole 41.

In this way, because the center point of the clutch roll 45 is disposed outside the first seating recess 21 and the second seating recess 11, the clutch roll 45 may be easily moved to the first seating recess 21 and the second seating recess 11 to be inserted into and disposed in the first seating recess 21 and the second seating recess 11 when the shaft is rotated.

In more detail, if the shaft 20 is forwardly rotated and passes by the first angle in a state in which the clutch roll 45 is inserted into and disposed in the first seating recess 21 and the through-hole 41, the first seating recess 21, the through-hole 41, and the second seating recess 11 are communicated with each other.

Then, the clutch roll 45, the center point of which is present outside the first seating recess 21, deviates from the first seating recess 21 through rotation of the shaft 20 and is inserted into and disposed in the first through-hole 41 and the second seating recess 11.

Further, if the shaft 20 is reversely rotated and passes by the first angle in a state in which the clutch roll 45 is inserted into and disposed in the second seating recess 11 and the through-hole 41, the first seating recess 21, the through-hole 41, and the second seating recess 11 are communicated with each other.

Then, the clutch roll 45, the center point of which is present outside the second seating recess 11, deviates from the first seating recess 21 through reverse rotation of the clutch member 40 due to an elastic restoring force of the torsion spring 60 and is inserted into and disposed in the first through-hole 41 and the second seating recess 11.

Further, in order to restrict the rotational angle of the shaft 20, a rotational groove 22 is formed long circumferentially on the outer peripheral surface of the shaft 20.

Further, a stopper 12, one end of which is inserted into and disposed in the rotational groove 22, is mounted in the housing 10.

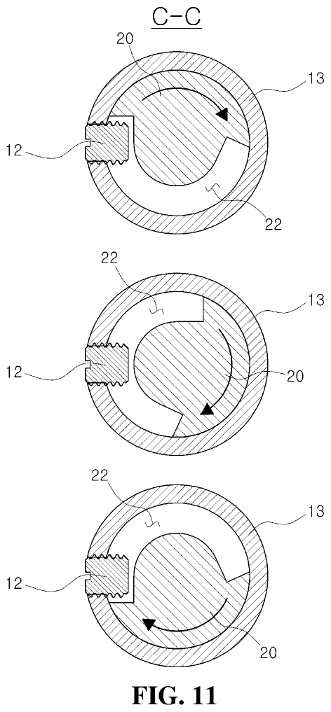

by the rotational groove 22 and the stopper 12, as illustrated in FIG. 11, the rotational angle of the shaft 20 is restricted as the shaft 20 is stopped by the stopper 12 inserted into the rotational groove 22 when the shaft 20 is rotated.

Meanwhile, the present invention may further include a height adjusting nut 71, a height adjusting ring 72, and a snap ring 73.

The height adjusting nut 71 is screw-coupled to an outer peripheral surface of one end of the first housing 13.

One end of the height adjusting ring 72 is exposed to the outside of one end of the adjusting nut 71 and one end of the housing 10, and an opposite end of the height adjusting ring 72 is inserted and disposed between the height adjusting nut 71 and the housing 10.

The snap ring 73 is disposed between the height adjusting nut 71 and the height adjusting ring 72 to be coupled such that the height adjusting nut 71 and the height adjusting ring 72 are moved together in the lengthwise direction of the housing 10.

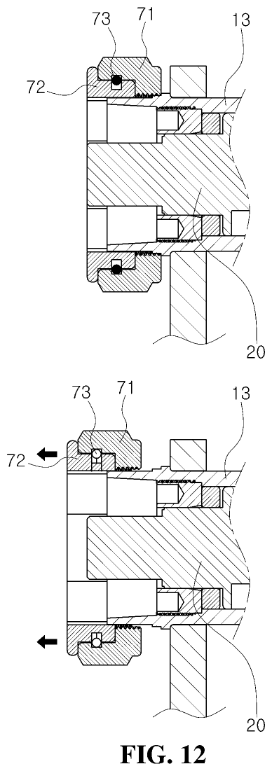

As illustrated in FIG. 12, because the height adjusting nut 71 is screw-coupled to the housing 10 when the height adjusting nut 71 is rotated with respect to the housing 10, the height adjusting nut 71 is moved in the lengthwise direction of the housing 10.

Then, a distance the height adjusting ring 72 coupled to the height adjusting nut 71 through the snap ring 73 between one end of the housing 10 is adjusted while the height adjusting ring 71 is moved in the lengthwise direction of the housing 10.

Because the height adjusting ring 72 is moved in the lengthwise direction of the housing 10 when the housing 10 is disposed vertically in a door of a refrigerator to be mounted through this, the distance between the housing 10 and the body object, that is, the body of the refrigerator is adjusted whereby the entire height of the hinge device may be adjusted.

Hereinafter, an operational process of the present invention including the above configuration will be described.

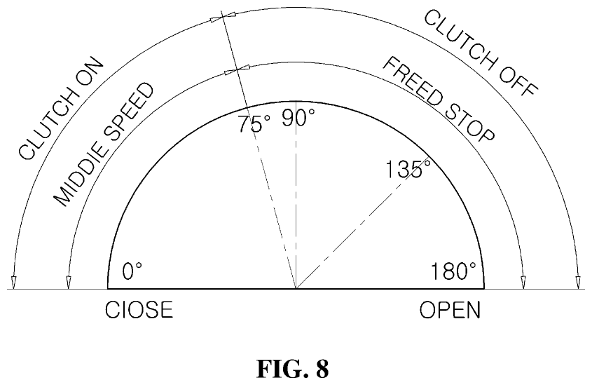

FIG. 8 is an illustration for explaining operations for angles of the hinge device for a rotary door according to the embodiment of the present invention when the hinge device is rotated.

As illustrated in FIG. 8, in the embodiment, the shaft 20 is divided into a compression section which corresponds to 0 degrees to 75 degrees clockwise and in which the shaft 20 is forwardly rotated while the torsion spring 60 is compressed, a free stop section which corresponds to a section that exceeds 75 degrees and in which the shaft is freely rotated independently, and a restoration section which corresponds to 75 degrees to 0 degrees counterclockwise and in which the shaft 20 is automatically reversely rotated by the elastic restoring force of the torsion spring 60 which has been compressed.

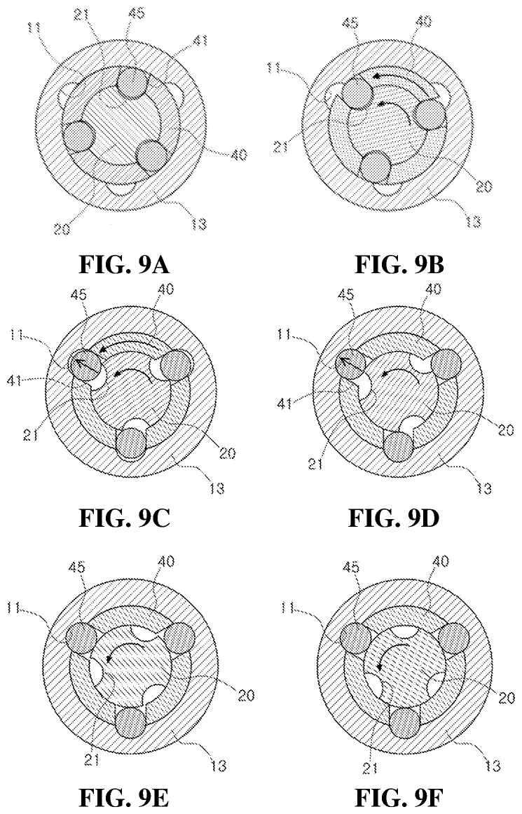

At the initial stop location at which the shaft 20 is not rotated, as illustrated in FIG. 9A, the clutch roll 45 is inserted into the through-hole 41 and the first seating recess 21.

Then, the torsion spring 60 applies a force for rotating the shaft 20 in a reverse rotational direction.

If the shaft 20 is forwardly rotated by an external force, as illustrated in FIG. 9B, the clutch member 40 is also rotated by the clutch roll 45 inserted into the first seating recess 21 of the shaft 20.

Then, the torsion spring 60 coupled to the clutch member 40 is further compressed gradually as the clutch member 40 is rotated.

As the shaft 20 is further rotated, it reaches a section in which the first seating recess 21, the through-hole, and the second seating recess 11 are communicated with each other, that is, the first angle, and the first angle is 75 degrees in the embodiment.

That is, when the shaft 20 is forwardly rotated, the torsion spring 60 is compressed while the shaft 20 and the clutch member 40 are rotated to the first angle together by the clutch roll 45.

In this state, if the shaft 20 is forwardly rotated further, as illustrated in FIG. 9C, the clutch roll 45 is pushed through rotation of the shaft 20 to deviate from the first seating recess 21 to cross the through-hole 41 and a portion of the clutch roll 45 is moved to the second seating recess 11.

As the clutch roll 45 is inserted into the through-hole 41 and the second seating recess 11, the clutch member 40 is stopped by the housing 10 through the clutch roll 45 and is prevented from being rotated further.

Accordingly, as illustrated in FIGS. 9C and 9D, as the shaft 20 is rotated to more than the first angle, the clutch roll 45 completely deviates from the first seating recess 21 and is inserted into and disposed in the through-hole 41 and the second seating recess 11, and accordingly, a free stop section in which the rotational force of the shaft 20 is not transferred to the clutch member 40 even if the shaft 20 is rotated.

Thereafter, as illustrated in FIGS. 9E and 9F, because the rotational force of the shaft 20 is not transferred to the clutch member 40 and the clutch roll 45 even if the shaft 20 is rotated to 180 degrees, only the shaft 20 is rotated while neither the clutch member 40 nor the clutch roll 45 is rotated, and the rotational force is not applied even to the torsion spring 60.

Then, a reverse rotational force by the torsion spring 60 is applied to the clutch member 40, and because the clutch member 40 is stopped by the housing 10 through the clutch roll 45, the clutch member 40 is maintained in a state in which the clutch member 40 is rotated to the first angle even if the reverse rotational force by the torsion spring 60 is applied.

Further, because the center point of the clutch roll 45 is located outside the second seating recess 11, the clutch roll 45 is stopped by the outer peripheral surface of the shaft 20 not to be moved and is inserted into and disposed in the through-hole 41 and the second seating recess 11 even if a force for moving the clutch roll 45 inwards in the second seating recess 11 by the reverse rotational force of the clutch member 40 by the torsion spring 60.

In this way, the shaft 20 may be rotated forwardly and reversely in the free stop type after the first angle at which the second seating recess 11 is formed.

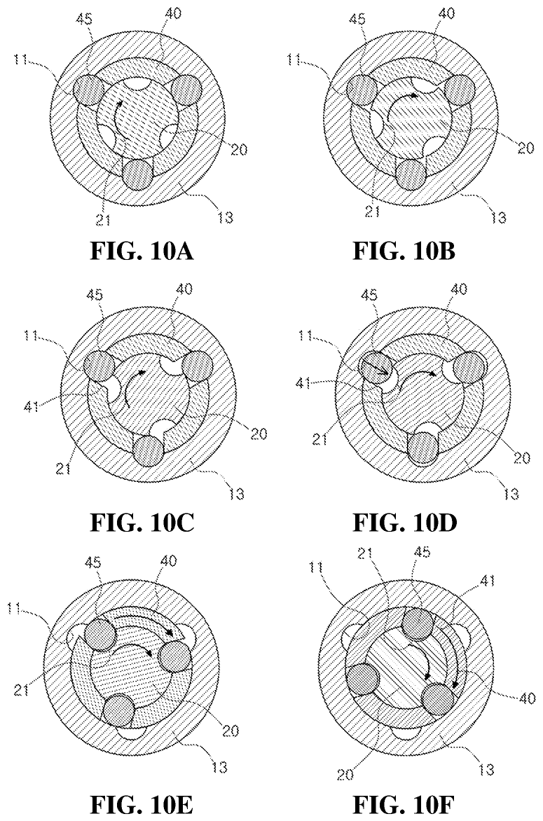

Meanwhile, when the shaft 20 is reversely rotated by an external force in a state in which the shaft 20 is forwardly rotated to exceed the first angle, as illustrated in FIGS. 10A to 10C, only the shaft 20 is freely rotated without any elastic restoring force of the torsion spring 60.

Then, as illustrated in FIG. 10D, if the shaft 20 is further reversely rotated and the first seating recess 21 is communicated with the through-hole 41, the clutch roll 45 is moved inwards in the second seating recess 11 by the reverse rotational force of the clutch member 40 by the torsion spring 60, and if the shaft 20 reaches the first angle, the clutch roll 45 gradually deviates from the second seating recess 11 and is gradually inserted into and seated in the through-hole 41 and the first seating recess 21.

From then, the clutch roll 45 deviates from the second seating recess 11 and the clutch member 40 is rotated reversely by the reverse rotational force by the elastic restoring force of the torsion spring 60 applied to the clutch member 40.

As a rotational force is applied reversely to the clutch member 40 by the torsion spring 60, as illustrated in FIG. 10E, a restoration section in which the clutch member 40 is automatically reversely rotated together with the shaft 20 through t eh clutch roll 45 is generated.

Accordingly, the shaft 20, as illustrated in FIG. 10F, returns to the initial stop location by the elastic restoring force of the torsion spring 60.

In this way, the present invention may be mounted on a door of a refrigerator to be used.

When the refrigerator door 81 is to be opened in a state in which the housing 10 is mounted on the body object 82 (the refrigerator body) and the shaft 20 is connected to the door that is rotating, the shaft 20 is compulsorily rotated to a preset first angle by an external force, in the remaining angle section that exceeds the first angle, the shaft 20 is rotated in a free stop type in which the shaft 20 is not automatically rotated, and when the refrigerator door 81 is to be closed, the shaft 20 and the refrigerator door 81 are automatically rotated and closed by the elastic restoring force of the torsion spring 60 if the rotated shaft 20 reaches the preset first angle.

In this way, because the shaft 20 and the refrigerator door are rotated in a free stop type in the section that exceeds the first angle in the present invention, the refrigerator door can be maintained in an opened state even if the user does not grip the refrigerator door in the state in which the shaft 20 exceeds the first angle, whereby a heavy and big item can be gripped by two hands or a large number of items can be easily inserted into or extracted from the refrigerator in a state in which the refrigerator is opened, and the refrigerator door can be automatically closed if the shaft 20 reaches the first angle through the reverse rotation.

In contrast, the shaft 20 may be connected to the body object 82 and the housing 10 may be mounted on the door 81, and then, the housing 10 can be rotated.

The hinge module for a rotary door of the present invention can be applied to a washing machine, a styler, a glass window, or a room door, which is mounted such that the door is rotated, as well as a refrigerator.

The hinge device for a rotary door of the present invention is not limited to the above-described embodiments, and may be variously modified within a range that is allowed by the technical sprit of the present invention.

What is claimed is:

1. A hinge device for a rotary door, comprising:
a hollow housing;
a shaft mounted in the interior of the housing to be rotatable, one end of which is exposed to the outside through one end of the housing, an opposite end of which is disposed in the interior of the housing, and in which a first seating recess is formed on an outer peripheral surface of the opposite end thereof;
a clutch roll inserted into and disposed in the first seating recess;
a clutch member, one end of which surrounds the opposite end of the shaft, having a first coupling boss protruding at an opposite end thereof, and in which a through-hole, into which the clutch roll is inserted to be disposed, is formed at the one end surrounding the shaft;
a support member mounted on the opposite end of the housing and having a second coupling boss protruding toward the interior of the housing; and
a torsion spring disposed in the interior of the housing, one end of which is coupled to the first coupling boss, and an opposite end of which is coupled to the second coupling boss,
wherein a second recess, in which the clutch roll inserted into the through-hole is seated, is formed on an inner peripheral surface of the housing,
wherein when the shaft is rotated in a state in which the clutch roll is inserted into both the first seating recess and the through-hole, a rotational force of the shaft is transferred to the clutch member through the clutch roll such that the clutch member is rotated together with the shaft, and
wherein when the shaft is rotated in a state in which the clutch roll is inserted into both the through-hole and the second seating recess, only the shaft is rotated independently while neither the clutch roll nor the clutch member is rotated.

2. The hinge device of claim 1, comprising:
a compression section, in which when the shaft is rotated forwardly by an external force, the clutch member compresses the torsion spring while being rotated together with the shaft to a preset first angle at an initial stop location;
a free stop section, in which when the shaft is rotated forwardly or reversely in a state in which the clutch exceeds the first angle, the shaft is freely rotated while the torsion spring is neither compressed nor released; and
a restoration section, in which when the shaft is rotated reversely toward the inside of the first angle in the free stop section, the shaft is automatically rotated reversely by an elastic restoring force of the torsion spring and is restored to the initial stop location.

3. The hinge device of claim 2, wherein the second seating recess is formed at a location corresponding to the first angle, the clutch roll is inserted into and disposed in the first seating recess and the through-hole in the compression section and the restoration section such that the shaft, the clutch roll, and the clutch member are rotated together, and the clutch roll is inserted into and disposed in the through-hole and the second seating recess in the free stop section such that the shaft is rotated independently from the clutch roll and the clutch member.

4. The hinge device of claim 3, wherein the depth of the first seating recess, the depth of the second seating recess, and the depth of the through-hole are smaller than the diameter of the clutch roll, the center point of the clutch roll is disposed outside the first seating recess in a state in which the clutch roll is inserted into and disposed in the first seating recess and the through-hole, and the center point of the clutch roll is disposed outside the second seating recess in a state in which the clutch roll is inserted into and disposed in the second seating recess and the through-hole.

5. The hinge device of claim 4, wherein if the shaft is rotated forwardly and passes by the first angle in a state in which the clutch roll is inserted into and disposed in the first seating recess and the through-hole, the clutch roll is separated from the first seating recess and is inserted into and disposed in the first through-hole and the second seating recess as the shaft is rotated while the first seating recess, the through-hole, and the second seating recess are communicated with each other, and
wherein if the shaft is rotated reversely and passes by the first angle in a state in which the clutch roll is inserted into and disposed in the second seating recess and the through-hole, the clutch roll is separated from the first seating recess and is inserted into and disposed in the first through-hole and the second seating recess as the shaft is rotated by the elastic restoring force of the torsion spring while the first seating recess, the through-hole, and the second seating recess are communicated with each other.

6. The hinge device of claim 3, wherein a reverse rotational force due to the elastic restoring force of the torsion spring is added to the shaft at the initial stop location.

7. The hinge device of claim 6, wherein the first seating recesses are disposed at an interval of 120 degrees, three clutch rolls are provided, the second seating recesses are disposed at an interval of 120 degrees, and the first angle is an angle that is smaller than 90 degrees at the initial stop location.

8. The hinge device of claim 1, wherein the housing comprises:
a first housing, in which the shaft is disposed in the interior thereof; and
a second housing, one end of which is coupled to an end of the first housing, in which the support member is mounted on an opposite end thereof, and in which the torsion spring is disposed in the interior thereof, and
wherein a stop boss protrudes circumferentially between the one end and the opposite end of the clutch member, and the stop boss is rotatable between the first housing and the second housing but is mounted such that a linear movement of the stop boss is stopped.

9. The hinge device of claim 8, further comprising:
a bearing surrounding the opposite end of the clutch member,
wherein one end of the bearing is stopped by and coupled to an inner peripheral surface of the one end of the second housing, and the stop boss is disposed between the bearing and the opposite end of the first housing to be rotatable but to be mounted such that a linear movement thereof is stopped.

10. The hinge device of claim 1, wherein a rotational groove is formed long on an outer peripheral surface of the shaft circumferentially, a stopper inserted into and disposed in the rotational groove is mounted on the housing, and when the shaft is rotated, the shaft is stopped by the stopper inserted into the rotational groove such that a rotational angle thereof is restricted.

11. The hinge device of claim 1, further comprising:
a height adjusting nut screw-coupled to one end of the housing;
a height adjusting ring, one end of which is exposed to the outside of one end of the height adjusting nut and one end of the housing and an opposite end of which is inserted and disposed between the height adjusting nut and the housing; and
a snap ring coupling the height adjusting nut and the height adjusting ring such that the height adjusting nut and the height adjusting ring are moved together lengthwise,
wherein when the height adjusting nut is rotated with respect to the housing, the height adjusting ring coupled through the snap ring is moved in the lengthwise direction of the housing such that the distance of the height adjusting ring from the one end of the hosing is adjusted.
